(19) United States
(12) Patent Application Publication
(10) Pub. No.: US 2011/0230242 A1
(43) Pub. Date: Sep. 22, 2011

(54) HEADSET PROTECTOR FOR USE WITH TELECOMMUNICATIONS DEVICE

(75) Inventors: Taisen Maddern, Melbourne (AU); Adrian Tan, Melbourne (AU)

(73) Assignee: BLUEANT WIRELESS PTY LIMITED, Richmond (AU)

(21) Appl. No.: 12/829,227

(22) Filed: Jul. 1, 2010

Related U.S. Application Data
(60) Provisional application No. 61/314,962, filed on Mar. 17, 2010.

(51) Int. Cl. H04M 1/00

(52) U.S. Cl. 455/575.8

(57) ABSTRACT

A headset protector for use with telecommunications devices such as mobile telephone headsets and earpieces. The headset protector or cover can be formed of a plastic, rubber, neoprene, or other suitable material, and include openings for microphones, buttons, or other features of the headset. In accordance with an embodiment, the headset protector or cover can be made of a waterproof or splash-resistant material. The headset protector or cover can optionally include features such as a belt-clip, or can be made to include different colors or patterns.

### CLAIM OF PRIORITY

This application claims the benefit of priority to U.S. Provisional Patent Application No. 61/314,962 titled “HEADSET PROTECTOR FOR USE WITH TELECOMMUNICATIONS DEVICE”, filed Mar. 17, 2010, of which application is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

The invention is generally related to telecommunications, audio headsets, speakers, and other communications devices, such as mobile telephones and personal digital assistants, and is particularly related to a headset protector for use with such devices.

### BACKGROUND

Telecommunications devices such as mobile telephone headsets and earpieces are in widespread usage, and nowadays it is common to see individuals sporting miniature wireless headsets as they go about their daily lives. In some regions, laws have recently been passed that outlaw the use of mobile telephone devices while driving unless the driver is using a hands-free headset or earpiece, to improve highway safety. As such, it is likely that the popularity of such devices will continue to increase.

An aspect of such devices that is often overlooked is that such headsets and earpieces are often quite expensive, and yet are prone to being placed in pockets, bags, and glove compartments, with coins, keys and other objects, where they can be easily scuffed or damaged. Additionally, such headsets and earpieces are typically quite small, and often appear similar to one another, which can lead to confusion among devices, and users mistaking their device for that of another's. This is the general area that embodiments of the present invention are intended to address.

### SUMMARY

Described herein is a headset protector for use with telecommunications devices such as mobile telephone headsets and earpieces. The headset protector or cover can be formed of a plastic, rubber, neoprene, or other suitable material, and include openings for microphones, buttons, or other features of the headset. In accordance with an embodiment, the headset protector or cover can be made of a waterproof or splash-resistant material. The headset protector or cover can optionally include features such as a belt-clip, or can be made to include different exterior colors or patterns.

### BRIEF DESCRIPTION OF THE DRAWINGS

FIG. 1 shows an illustration of a headset protector or cover being used with a headset, in accordance with an embodiment.

FIG. 2 shows an illustration of different views of a headset and headset protector or cover, in accordance with an embodiment.

### DETAILED DESCRIPTION

Described herein is a headset protector for use with telecommunications devices such as mobile telephone headsets and earpieces. The headset protector or cover can be formed of a plastic, rubber, neoprene, or other suitable material, and include openings for microphones, buttons, or other features of the headset. In accordance with an embodiment, the headset protector or cover can be made of a waterproof or splash-resistant material. The headset protector or cover can optionally include features such as a belt-clip, or can be made to include different exterior colors or patterns.

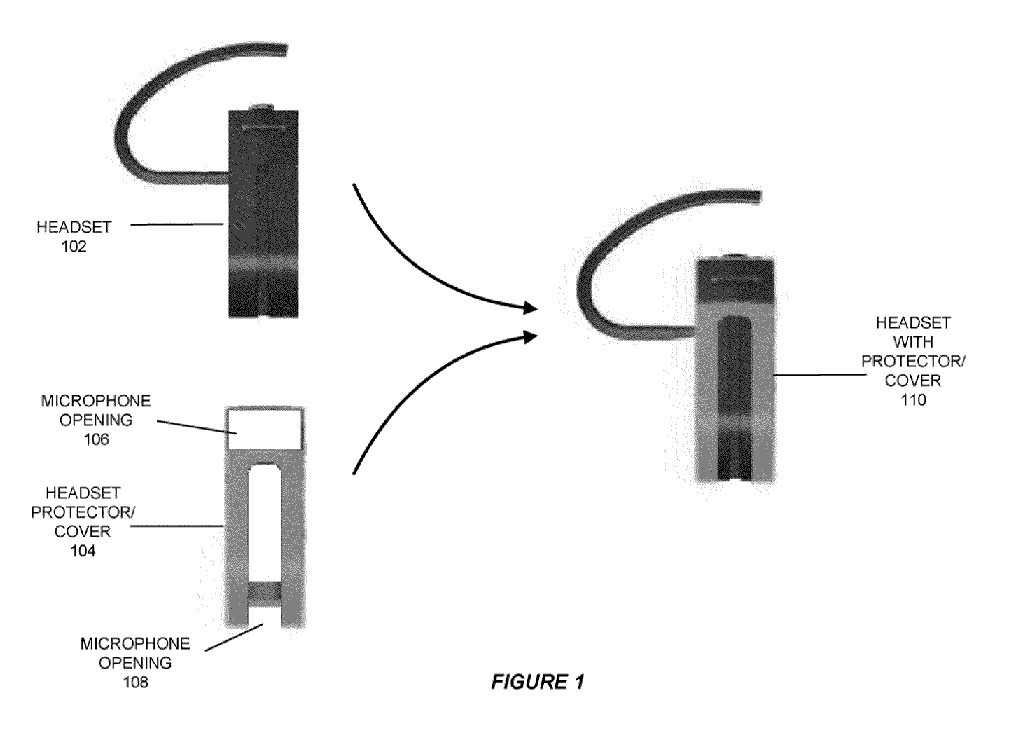

FIG. 1 shows an illustration of a headset protector or cover being used with a headset, in accordance with an embodiment. For purposes of illustration, the device shown in FIG. 1 and generally described throughout this description is a telecommunications headset device, such as a Bluetooth-enabled headset that might be used with a mobile telephone. In accordance with various embodiments some or all of the features disclosed herein can be similarly used or implemented within other communications devices, such as different types of headset or wireless earpiece.

As shown in FIG. 1, the headset 102 typically includes an earpiece and/or speaker assembly that can be placed near or in the user's ear, and which allows the user to listen to the headset. The headset typically also includes an ear hook or other means for securing the headset to the user's ear. Other communications devices can include similar features.

In accordance with an embodiment, a headset protector or cover 104 is provided as a housing which is generally sized and shaped to fit around the headset, earpiece, or telecommunications device, and which provides protection from knocks or scuffs, such as if the user drops the headset. The headset protector or cover can be formed of a plastic, rubber, neoprene, or other suitable material, and can be optionally removed from, and replaced onto the telecommunications device. The headset protector or cover can include openings 106, 108 positioned appropriately for microphones, buttons, or other features of the headset, to allow these features to be accessed without removing the headset from its cover.

In accordance with an embodiment, the headset protector or cover can be made of a waterproof or splash-resistant material, and when placed on the headset 110 can include appropriate plugs to protect otherwise-exposed connectors on the headset against intrusion from dust or liquids. The headset protector or cover can optionally include features such as a belt-clip, or can be made to include different exterior colors or patterns, to help distinguish one person's headset from another's, or as a fashion statement.

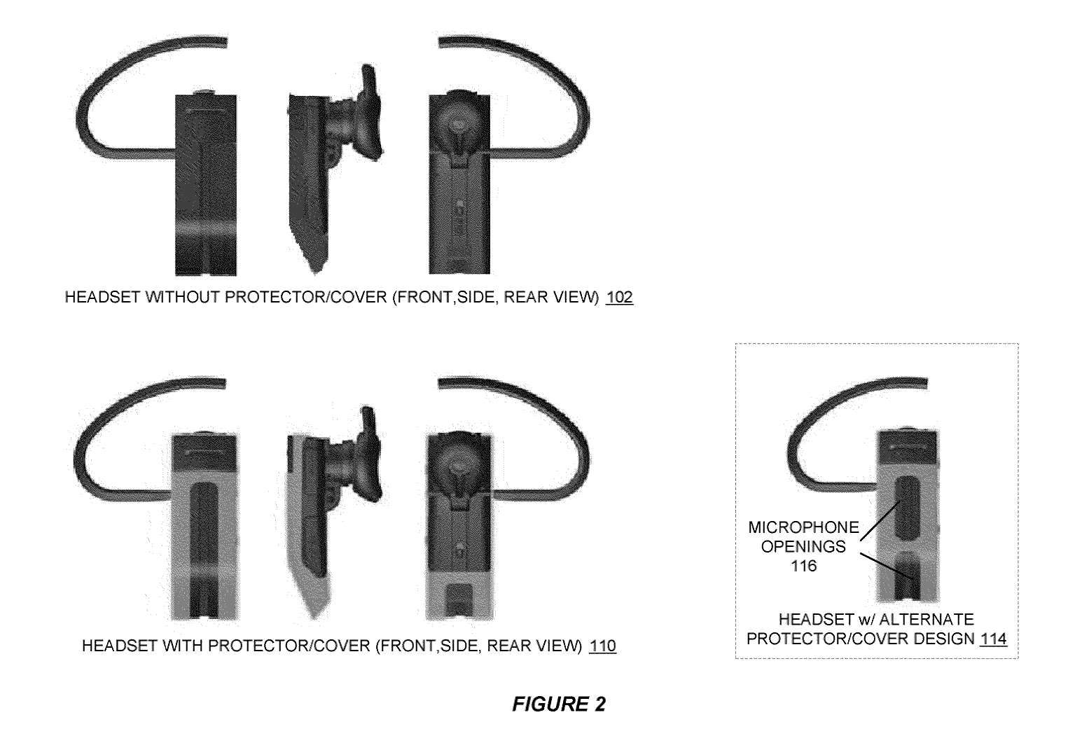

FIG. 2 shows an illustration of different views of a headset and headset protector or cover, in accordance with an embodiment. As shown in FIG. 2, when used without a cover, the headset alone 102 is exposed on its front, side, and rear, which can lead to damage both from accidental knocks, and from intrusion of dust or liquids.

When instead the headset is used with a protector or cover 110 in accordance with an embodiment, the headset is somewhat protected from accidental damage, while the openings in the protector or cover still allow the headset to be worn, and its microphones, buttons, or other features to be accessed without removing the protector or cover.

FIG. 2 also illustrated an alternate cover design 114, which includes a different arrangement of microphone openings. It will be evident that different shapes, designs, and numbers and positions of openings can be provided to suit different types of headset, earpiece, or telecommunications device, in accordance with other embodiments.

The foregoing description of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A headset protector or cover for use with a telecommunications device such as a mobile telephone headset or earpiece, comprising:
a housing formed of a plastic, rubber, neoprene, or other suitable material, shaped to fit upon a telecommunications device such as a mobile telephone headset or earpiece, and including openings for microphones, buttons, or other features of the headset.

2. The headset protector or cover of claim 1, wherein the headset protector or cover can be optionally removed from, and replaced onto the telecommunications device.

3. The headset protector or cover of claim 1, wherein the headset protector or cover is made of a waterproof or splash-resistant material.

4. The headset protector or cover of claim 1, wherein the headset protector or cover includes a belt-clip

5. The headset protector or cover of claim 1, wherein the headset protector or cover can be made to include different exterior colors or patterns.
